(19) United States
(12) Patent Application Publication
(10) Pub. No.: US 2022/0000155 A1
(43) Pub. Date: Jan. 6, 2022

(54) Soluble Flour For Use In Food Applications

(71) Applicant: Cargil, incorporated, Wayzata, MN (US)

(72) Inventors: Avi GOLDSTEIN, Minneapolis, MN (US); Xian-Zhong HAN, Maple Grove, MN (US); Varatharajan VAMADEVAN, Plymouth, MN (US)

(73) Assignee: Cargil, Incorporated, Wayzata, MN (US)

(21) Appl. No.: 17/289,892

(22) PCT Filed: Oct. 31, 2019
(86) PCT No.: PCT/US19/59104

§ 371 Date: Apr. 29, 2021

Related U.S. Application Data
(60) Provisional application No. 62/754,654, filed on Nov. 2, 2018.

(51) Int. Cl. A23L 23/10; A23L 27/60

(52) U.S. Cl. CPC A23L 23/10; A23V 2002/00; A23L 27/60

(57) ABSTRACT

An instant or prepared sauce or dry mix seasoning comprising a soluble flour and at least one additional ingredient, wherein the soluble flour has a dextrose equivalent value ranging from 5 to 18, a solubility greater than 50% at 5% solids, and a viscosity between 0.001 and 1.0 Pa*s at temperatures ranging from 20-50 C at 10% solids.

This application claims the benefit of U.S. Provisional Application No. 62/754,654, filed Nov. 2, 2018, entitled Soluble Flour For Use in Food Applications, which is hereby incorporated by reference in its entirety.

### TECHNICAL FIELD

This application relates to soluble flour compositions and their use in food applications.

### BACKGROUND

Consumers are asking for label friendly alternatives to maltodextrin in food and beverage applications. While there is a desire to create label-friendly alternatives, there is also a desire for such alternatives to have similar functionality as that of maltodextrin.

### SUMMARY

Described herein is an instant or prepared sauce or dry mix seasoning comprising a soluble flour and at least one additional ingredient, wherein the soluble flour has a dextrose equivalent value ranging from 5 to 18, a solubility greater than 50% at 5% solids, and a viscosity between 0.001 and 1.0 Pa*s at temperatures ranging from 20-50 C at 10% solids.

### FIGURES

FIG. 1 illustrates the process of manufacturing the soluble flour as described herein.

FIG. 2 graphically illustrates viscosities of the soluble flour as described herein in water (10 wt % soluble flour concentration).

FIG. 3 graphically illustrates the particle size distribution of soluble cassava flour.

FIG. 4 graphically illustrates the particle size distribution of soluble rice flour.

FIG. 5 graphically illustrates the particle size distribution of soluble rice flour dried at various slurry dry solid levels.

### DETAILED DESCRIPTION

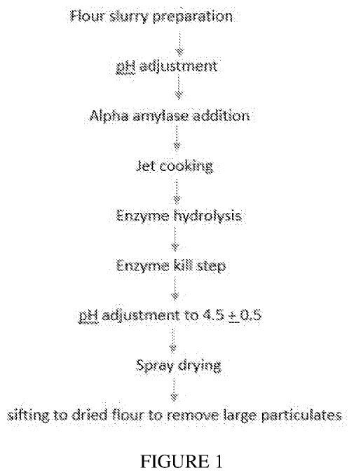

Described herein is a soluble flour composition that can be used in food and beverage applications as a maltodextrin replacer, and a method of manufacturing the same. As used herein, the term “soluble flour” also includes hydrolyzed, enzymatically treated, enzymatically-modified, and/or solubilized flour. Such soluble flour has been treated to promote greater solubility of their principle components in liquids such as water. Further, such soluble flour demonstrates similar functionality as that of maltodextrin, has a desirable “clean flavor”, mouthfeel, and texture suitable for food and beverage applications. An illustration of the general process can be found in FIG. 1. As used herein, the term “soluble” is referencing solubility of flour components in water. As used herein, the term “flour” encompasses (1) non-grain flours and (2) fractionated, non-whole grain flours wherein a portion of bran and germ have been removed.

The first step in the production process is preparing a slurry made up of flour and water. The flour can be of many sources, for example but not limited to, non-grain sources such as root or tuber sources, and more specifically potato, cassava, sweet potato, taro, yam, arrowroot, lotus root, shoti, Kudzu, banana, waxy cassava, waxy tapioca, or grain flours such as rice, waxy cereal flours, normal cereal flours, or high amylose cereal flours. Sugary-1 mutant flours, and flours containing phytoglycogen can also be used. Flours used as starting materials inherently have low levels of solubility in water.

In preferred aspects, the flour is either cassava flour or rice flour. The slurry comprises about 15 wt % to 35 wt % of the flour, and in more preferred aspects comprises about 20 wt % to 30 wt % flour. In preferred aspects, the slurry is agitated by an agitation means to prevent settling of the flour solids.

The slurry is then pH adjusted to a desirable pH ranging from about 3.5 to 6.0. In preferred aspects from 4.5 to 5.5, in more preferred aspects from 4.7 to 5.3, and in most preferred aspects from 4.8 to 5.2. The pH can be adjusted using acid solutions such as hydrochloric acid.

Once the pH of the slurry is adjusted to fall within the desired range, an enzyme is then added to the slurry. In preferred aspects, the enzyme is an alpha-amylase enzyme, however other bacterial or fungal enzymes may also be used, for example but not limited to isoamylase, glucoamylase-, beta-amylase, pullulanase, and/or combinations thereof. In preferred aspects, the alpha-amylase is a thermal stable alpha-amylase. In preferred aspects, the enzyme is added in an amount ranging 0.02-0.1% enzyme relative to weight of the flour, and more preferably from 0.045-0.085% enzyme relative to weight of the flour, to form a reaction mixture. The enzyme and slurry make up the reaction mixture. The reaction mixture can be treated at a temperature ranging from 60° C. to 140° C., preferably 85° C. to 140° C., more preferably 90° C. to 100° C., such treatment promotes gelatinization and further solubilization. The reaction mixture is treated until a dextrose equivalent (“DE”) of between 5 and 18 is achieved. In preferred aspects, the cooking would take place until a DE of between 8 and 12 is achieved. Preferably, a jet cooker is used to facilitate the reaction. Once the reaction is complete and the desired DE is achieved, the enzyme is inactivated utilizing common methods such as the addition of acid or heat, and a soluble flour is obtained. The soluble flour is cooled to a temperature ranging from 50 C to 60 C and the pH of the soluble flour is adjusted to a range from about 3 to about 5. The pH can be adjusted using base solutions such as sodium hydroxide. The soluble flour can undergo additional processing, for example evaporation, spray drying and sifting.

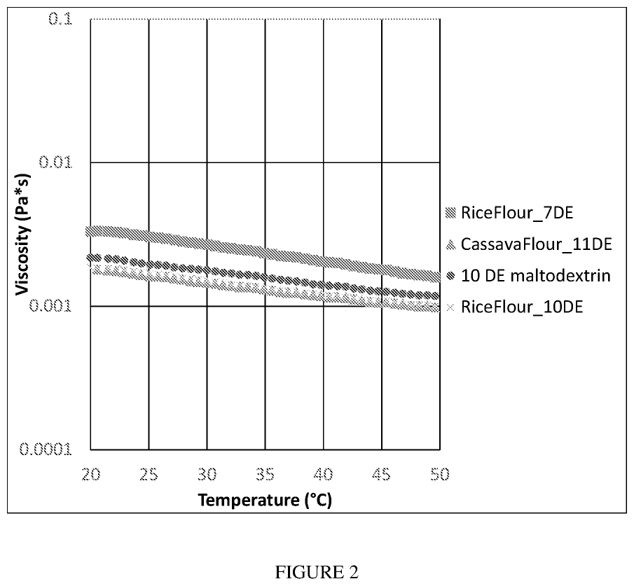

The obtained soluble flour has a solubility ranging from 50% to 100%, (measured at 5% soluble flour concentration also referred to as “5% solids”), and more preferably a solubility ranging from 75% to 85%, and a DE value ranging from 5 to 18 and more preferably a DE value ranging from 8 to 12. The soluble flour also demonstrates desirable viscosity characteristics in water (10 wt % soluble flour concentration also referred to as “10% solids”) ranging from 0.001 and 1 Pa*s. In preferred aspects, the soluble flour has a viscosity ranging from 0.001-0.01 Pa*s at temperatures ranging from 20-50 C as shown in FIG. 2. In some aspects, the viscosity characteristics of the soluble flour in water ranges from 0.001 to 0.1 Pa*s.

The soluble flour-water sample was made using an overhead propeller mixer to dissolve soluble solids at 8000 rpm and were tested using an Anton Paar MCR 502 rheometer couette geometry at 20 s⁻¹ of shear rate. The soluble flour also has desirable molecular weight distribution profiles and polydispersity characteristics. Solubility of flours were determined by thoroughly mixing soluble flours in water (5% solids), filtering the sample mixture through filter paper, and determining % Brix of the filtrate using a DR301-95 Digital Refractometer (Kruss GmbH, Hamburg, Germany). In order to determine solubility from the experimentally determined % Brix, one must complete a calculation accounting for the percent of total solids initially added to the system. The DE values of spray dried soluble flours was achieved by quantifying the amount of reducing sugars by Schoolr's method analysis.

In preferred aspects, the soluble flour has a protein content ranging from 0 to 10 wt %, from 0.01 to 10 wt %, and from 0.1 to 10 wt %. In preferred aspects, the soluble flour has a dietary fiber content ranging from 0.5 to 15 wt %.

The soluble flour as described herein is desirable for use in food applications. Notable food applications include but are not limited to beverages, beverage mixes, infant food, medicinal products, food emulsions, convenience foods, bakery, dairy, and snack-based fillings or food products. Beverages and beverage mixes can include instant mixes for hot or cold beverages, flavored milk including chocolate milk, carbonated soft drinks, fruit juices, sports beverages, nutrition beverages, and infant formula. Dairy food products can include ice cream, yogurt, sour cream, whip cream, and non-dairy vegan alternatives. Convenience foods include but are not limited to salad dressings (pourable and spoonable), sauces (instant and prepare), condiments, puddings, bars, cereals, coatings for cereal, spreads, low-fat spreads, icings, hard candies, soft candies, gummy products, and dry mix seasonings. Bakery food applications can include cookies, cakes, muffins, crackers, pastries, and laminated baked products.

The soluble flour as described herein can be used as at least a partial replacement of maltodextrin in instant and prepared sauce and dry mix seasoning food applications and in many cases can be used to fully replace maltodextrin in instant and prepared sauce and dry mix seasoning food applications. The soluble flour demonstrates similar functionality (e.g., pH, solubility, and viscosity) as maltodextrin making it a suitable replacement for maltodextrin in instant and prepared sauce and dry mix seasoning food applications. Such replacement allows for consumer-friendly labelling as soluble flours may be more well received by some consumers as compared to maltodextrin.

Further, such soluble flour additionally has the capability to replace maltodextrins in flavor encapsulation applications wherein a flavor emulsion is created and spray dried, to convert a liquid flavor into a solid. In these applications maltodextrins may be used alongside a lipophilic starch, or alternately used alone to create a flavor emulsion. Maltodextrins are typically used in this space due to their ability to form matrices that positively contribute to encapsulation. The soluble flour described herein can replace maltodextrins in this space due to their bland flavor, low viscosity, and low cost. Additionally, soluble flours can replace maltodextrin in plating oil-based flavors.

In preferred aspects, the soluble flour as described herein can be used for instant sauces (e.g., dry mix that is reconstituted to a sauce formed by the consumer), prepared sauces, dry mix seasoning, and flavor encapsulation. Such soluble flours can be added in varying amounts and consistently demonstrate similar taste and functionality as maltodextrin.

### EXAMPLES

### Example #1: Manufacturing Process to Prepare Soluble Flour

In a mixing tank, prepare 25% (w/w flour solids) flour slurry in water using 10 Kg flour (wet basis). Table 1 provides information on starting corn maltodextrin, cassava flour, and rice flour materials. Maintain slurry at ambient temperature. Mixing speed should be adjusted to prevent settling of flour solids.

TABLE 1

| | |
|---|---|
| Maltodextrin | Cargill “Dry MD” 01909 common corn 10 |
| | DE maltodextrin |
| Cassava Flour | Premium Cassava Flour (American Key |
| | Food Products, Closter, New Jersey, USA) |
| Rice Flour | Medium/Short Grain White Rice Flour |
| | Fine-7011 (PGP International, Woodland, |
| | California, USA) |

The pH of the slurry in the tank is adjusted to pH of 4.8-5.2 using 1:1 HCl acid solution. After pH adjustment, the slurry will continue to be mixed at gentle speed. Thermal-stable alpha amylase enzyme (0.045-0.085% enzyme relative to weight of the flour) is then added to the slurry. After 5 minutes of mixing, slurry pH is measured again to confirm it is within desired range of (4.8-5.2) and slurry temperature is recorded. Ideal product temperature is between 15-25° C.

Using water as the feed for the jet cooker, equilibrate cooking temperature between 110-117° C. and outlet temperature of 95° C. (atmospheric flash in product tank). Once the cooking conditions are set, start feeding the flour slurry into the jet cooker. Collect liquefact into product tank which is equipped with overhead mixer. The collection tank should be able to control temperature up to 95° C.

Hold liquefacts in product tank at 95° C. for a desired holding time that corresponds to a DE (extent of hydrolysis) value desired in final products (typically targeting a DE between 8 and 12). To increase the rate of reaction, additional alpha amylase can be added at this point (0.025-0.035% enzyme relative to weight of the flour). Continue mixing the liquefacts at a slow speed to avoid splashing of hot liquid.

Soon after completion of desired holding times, adjust pH to 2.7-3 at 95° C. and hold for 15 minutes. Continue mixing the liquefacts at a slow speed to avoid splashing of hot liquid. To ensure complete inactivation of enzyme, accurately control temperature and holding time of 15 minutes. After required hold time, adjust pH to 4.5±0.5 in liquefacts using NaOH base solution.

Soon after completion of enzyme kill step, slurry temperature is adjusted to 50-65° C. Transfer approximately 8-10 L of hot liquefact (at 65-75° C.) from product tank to a 5 gallon white plastic pail Immerse this plastic pail into a 80° C. water bath with overhead agitation. Feed deionized water into the spray dryer to equilibrate the inlet temperature of the dryer to approximately 200° C. and the outlet temperature to approximately 100° C. Switch the feed from water to liquefact. Collect dried product, and store in air tight packaging.

Optionally, sift dried soluble flour product through a 425 micron (μm) screen to remove any large particulates which may have been formed during the drying process.

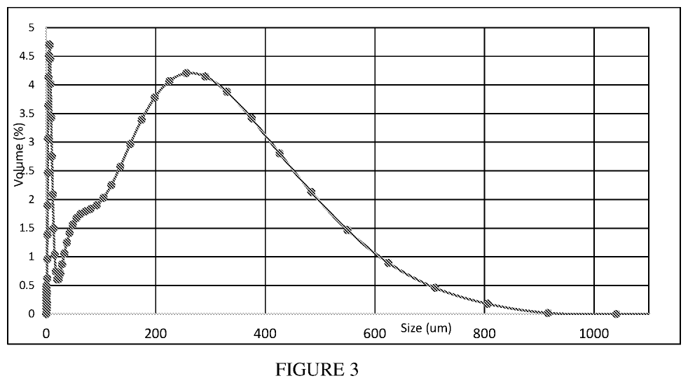

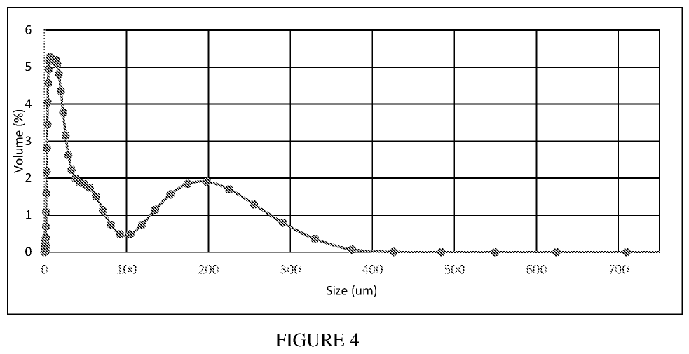

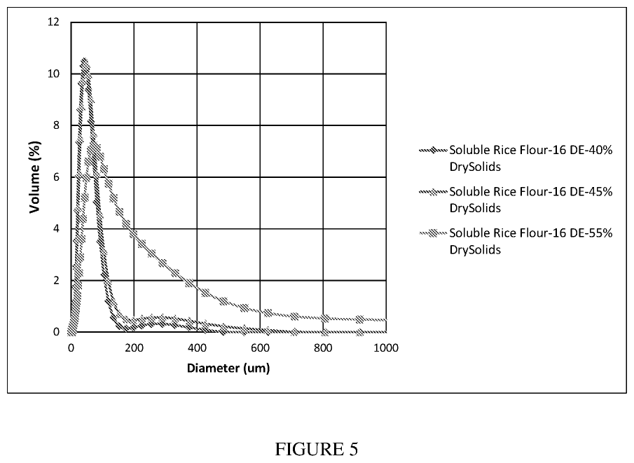

Table 2 provides solubility (measured at 5% solids) and DE data of the soluble flours, Table 3 provides the molecular weight distribution of the soluble fours, and Table 4 provides information on composition per 100 g of final soluble flour product. Note the data in Table 3 represents the mass distribution of the soluble component within the flour products. Molar mass was determined using the SEC MALS RI method described in Example #5. FIGS. 3 and 4 show the particle size distribution of soluble cassava flour and rice flour, respectively. FIG. 5 shows that you may optionally vary the slurry dry solids content to improve the efficiency of drying, which would have an impact on particle size distribution.

TABLE 2

| Sample | Solubility (%) | DE |
|---|---|---|
| Cargill Dry MD 01909 | 100 | 10 |
| Soluble Rice Flour | 81 | 8.3 |
| Soluble Cassava Flour | 81 | 11.5 |

TABLE 3

| | | Soluble | Soluble | Cargill |
|---|---|---|---|---|
| | Molar Mass | Cassava | Rice | Dry MD |
| DP | (Da) | Flour | Flour | 01909 |
| 1 −> 5 | 0-909 | 0 | 0 | 10 |
| 6 −> 9 | 909-1557 | 0 | 0 | 13.13 |
| 10 −> 19 | 1557-3177 | 0 | 14 | 17.95 |
| 20 −> 45 | 3177-7389 | 0 | 9 | 6.55 |
| 46 −> 125 | 7389-20349 | 8 | 20 | 9.26 |
| 126 −> 280 | 20349-45459 | 65 | 21 | 13.66 |
| 281 −> 600 | 45459-97299 | 16 | 15 | 11.76 |
| 601 −> 1500 | 97299-243828 | 7 | 12 | 11.07 |
| >1500 | >243828 | 3 | 9 | 6.61 |
| | DE | 10 | 8 | 11.5 |
| | Mn (kDa) | 31 | 9 | 2.5 |
| | Mw (kDa) | 59 | 78 | 59 |
| | Polydispersity | 1.9 | 8.6 | 23 |
| | (Mw/Mn) | | | |
| | rh(v)z (nm) | 8 | 9 | <10 |

TABLE 4
Approximate Composition per 100 g final product

| | | | Dietary | | |
|---|---|---|---|---|---|
| | Carbohydrate | Fat | Fiber | Protein | Ash |
| Ingredient | (wt %) | (wt %) | (wt %) | (wt %) | (wt %) |
| Cargill 01909 | 95 | 0.01 | 0 | 0 | 0.01 |
| (common corn | | | | | |
| 10 DE | | | | | |
| maltodextrin) | | | | | |
| Soluble | 81 | <0.5 | 10.8 | 1.5 | 1.26 |
| Cassava Flour- | | | | | |
| Final product | | | | | |
| Soluble Rice | 82 | 0.8 | 0.9 | 6.8 | 0.8 |
| flour-final | | | | | |
| product | | | | | |

### Example #2: Molar Mass Distribution Method

### Instruments:

HPLC: Agilent 1260 Infinity System
Multi-angle light scattering Detector (MALS): Wyatt Technology DAWN HELEOS II
Refractive Index Detector (RI): Wyatt Technology Optilab TrEX
Column Heater
Instrument Set Up: HPLC-Column heater-MALS-RI

### Columns:

Phenomenex Phenogel 10 u (7.8×300 mm)
   Columns in series: guard column-10E6A-10E5A-10E3A
Column Temperature: 55° C.

### Sample Preparation Procedure:

1. Add 100 mg sample into a 25×150 mm culture tube with cap.
   Note: Before sample addition remove particles from tube & cap using canned air (Duster)
2. Add 20 mL of 50 mM LiBr 100% DMSO mobile phase (isocractic, run time; 70 minutes) to the tube using a 25 mL graduated cylinder.
   Note: Make sure to wash down any sample stuck on the tube sides.
3. Add mini-stir bar and immediately set on stir plate.
4. Stir samples for 1 hour at low rpm.
5. Place tubes in water bath.
6. Heat water until vigorous boil with continuous sample solution stirring.
7. Turn off hot plate.
8. Leave samples in the water bath stirring on hot plate until tubes are at room temperature.
9. De-pressurize the tubes by quickly loosening then re-tightening the cap.
10. Mix samples with vortex mixer.
11. Place samples on stir plate and stir overnight.
12. Filter sample through a 1 um PTFE syringe filter into a 2 mL HPLC vial.
13. Analyze samples by SEC-MALLS-RI system.

### Example #3: Soluble Flours in Gravy Dry Mix (Instant Sauce)

Combine all dry ingredients listed in Tables 5, 6, and 7 and chicken broth in a Vorwerk (Thermomix TM5-4) jacketed mixing kettle. Set mixing speed to 3.5 (Medium-low setting) and heat to 90° C. Hold mixture at 90° C. for 5 minutes. Add oil to Vorwek and mix for 5 minutes. While product is still hot, fill into containers and immediately place containers in ice water bath to cool. Place in refrigeration and reserve sample for viscosity testing-measure sample between 60-65° C.

TABLE 5

| Maltodextrin | % |
|---|---|
| 33% REDUCED SODIUM CHICKEN BROTH | 92.2 |
| Waxy Starch (Cargill Gel 04230) | 4 |
| Vegetable Oil | 1.1 |
| Maltodextrin, 10DE (Cargill Dry MD 01909) | 1.1 |
| All Purpose Flour | 1.6 |
| Total | 100 |

TABLE 6

| Cassava | % |
|---|---|
| 33% REDUCED SODIUM CHICKEN BROTH | 92.2 |
| Waxy Starch (Cargill Gel 04230) | 4 |
| Vegetable Oil | 1.1 |
| Soluble Cassava Flour | 1.1 |
| All Purpose Flour | 1.6 |
| Total | 100 |

TABLE 7

| Rice | % |
|---|---|
| 33% REDUCED SODIUM CHICKEN BROTH | 92.2 |
| Waxy Starch (Cargill Gel 04230) | 4 |
| Vegetable Oil | 1.1 |
| Soluble Rice Flour | 1.1 |
| All Purpose Flour | 1.6 |
| Total | 100 |

The samples were evaluated after stirring and heating to 65 C in a microwave. After stirring and heating samples, there were no signs of syneresis or separation. The soluble cassava and rice flour samples had similar flavor and texture profiles to the maltodextrin sample. Furthermore, the viscosity data in Table 8 shows soluble cassava and rice flours samples had similar viscosity characteristics as the maltodextrin control.

TABLE 8

| | Initial (63° C.) | | 5 days (63° C.) | |
|---|---|---|---|---|
| | Brookfield | Bostwick | Brookfield | Bostwick |
| | (cP) | (cm) | (cP) | (cm) |
| Control | 837.8 cP | 24+ | 759.8 cP | 24+ |
| Soluble Rice | 896.9 | 24+ | 721.8 cP | 24+ |
| Flour | | | | |
| Soluble Cassava | 802.8 | 24+ | 751.8 cP | 24+ |
| Flour | | | | |

Brookfield viscosity data of gravy samples (n = 3). Settings: Spindle 62, 10 RPM. Gravy temperature: 63° C.

### Example #4: Soluble Flours in Taco Sauce (Prepared Sauce)

Combine all dry ingredients listed in Tables 9, 10, and 11 and water in a Vorwerk jacketed mixing kettle. Set mixing speed to 3.5 (Medium-low setting) and heat to 90° C. Hold mixture at 90° C. for 5 minutes. While product is still hot, fill into containers and immediately place containers in ice water bath to cool. Place in refrigerator. Reserve sample for viscosity testing—measure sample between 60-65° C.

TABLE 9

| Maltodextrin | % |
|---|---|
| Tomato Paste | 18 |
| Water | 69.5 |
| Vinegar | 8 |
| Xanthan gum | 0.2 |
| Maltodextrin, 10DE | 1.5 |
| (Cargill Dry MD 01909) | |
| Sugar | 0.8 |
| Salt | 1 |
| Garlic powder | 0.2 |
| Cumin | 0.4 |
| Chili powder | 0.2 |
| Paprika | 0.2 |
| Cayenne | 0 |
| Total | 100 |

TABLE 10

| Soluble Rice Flour | % |
|---|---|
| Tomato Paste | 18 |
| Water | 69.5 |
| Vinegar | 8 |
| Xanthan gum | 0.2 |
| Soluble Rice Flour | 1.5 |
| Sugar | 0.8 |
| Salt | 1 |
| Garlic powder | 0.2 |
| Cumin | 0.4 |
| Chili powder | 0.2 |
| Paprika | 0.2 |
| Cayenne | 0 |
| Total | 100 |

TABLE 11

| Soluble Cassava Flour | % |
|---|---|
| Tomato Paste | 18 |
| Water | 69.5 |
| Vinegar | 8 |
| Xanthan gum | 0.2 |
| Soluble Cassava Flour | 1.5 |
| Sugar | 0.8 |
| Salt | 1 |
| Garlic powder | 0.2 |
| Cumin | 0.4 |
| Chili powder | 0.2 |
| Paprika | 0.2 |
| Cayenne | 0 |
| Total | 100 |

The samples were evaluated at room temperature to mimic the circumstance in which the prepared sauce would be utilized. There were no signs of syneresis or separation in any of the samples after 5 days of store in refrigeration. The soluble cassava and rice flour samples had similar flavor and texture profiles to the maltodextrin sample and appearance was substantially similar. Furthermore, the viscosity data in Table 12 shows soluble cassava and rice flours samples had similar viscosity characteristics as the maltodextrin control.

TABLE 12

| | Initial (63° C.) | | 5 Days (21° C.) | |
|---|---|---|---|---|
| | Brookfield | Bostwick | Brookfield | Bostwick |
| | (cP) | (cm) | (cP) | (cm) |
| Control | 1928 | 18 | 2669 | 14.5 |
| Maltodextrin | | | | |
| Soluble Rice | 1937 | 19.5 | 2234 | 17 |
| Flour | | | | |
| Soluble | 2271 | 16 | 2809 | 15 |
| Cassava Flour | | | | |

Brookfield viscosity data of taco sauce samples (n = 3). Settings: Spindle 62, 10 RPM. Taco sauce temperature initial: 63° C., 5 days: 21.1° C.

### Example #5: Soluble Flours in Dry Taco Seasoning (Dry Mix Seasoning)

For the dry seasoning blend, combine all ingredients in Tables 13, 14, and 15 into a mixing bowl. Stir ingredients by hand with a spoon until the seasoning blend is homogenous. Add seasoning blend to container and store in a cool place until time of use.

To incorporate the dry seasoning blend with cooked meat, add 40 grams of the taco seasoning mix and ¾ cups of water to 1 pound of cooked ground beef. Bring sauce to a boil and reduce to simmer Simmer for 5 minutes and serve hot.

TABLE 13

| Maltodextrin | % |
|---|---|
| Maltodextrin, 10DE | 20.00 |
| (Cargill Dry MD 01909) | |
| Salt | 14.25 |
| Cumin | 16.25 |
| Sugar | 7.50 |
| Black Pepper | 6.00 |
| Chili Powder | 13.00 |
| Paprika | 6.00 |
| Dried Oregano | 6.00 |
| Garlic Powder | 6.00 |
| Onion Powder | 3.00 |
| Modified Starch-Polartex 06732 | 2.00 |
| Total | 100.00 |

TABLE 14

| Rice | % |
|---|---|
| Soluble Rice Flour | 20.00 |
| Salt | 14.25 |
| Cumin | 16.25 |
| Sugar | 7.50 |
| Black Pepper | 6.00 |
| Chili Powder | 13.00 |
| Paprika | 6.00 |
| Dried Oregano | 6.00 |
| Garlic Powder | 6.00 |
| Onion Powder | 3.00 |
| Modified Starch-Polartex 06732 | 2.00 |
| Total | 100.00 |

TABLE 15

| Cassava | % |
|---|---|
| Soluble Cassava Flour | 20.00 |
| Salt | 14.25 |
| Cumin | 16.25 |
| Sugar | 7.50 |
| Black Pepper | 6.00 |
| Chili Powder | 13.00 |
| Paprika | 6.00 |
| Dried Oregano | 6.00 |
| Garlic Powder | 6.00 |
| Onion Powder | 3.00 |
| Modified Starch-Polartex 06732 | 2.00 |
| Total | 100.00 |

56 individuals participated in a sensory panel. Ground beef samples were cooked until the internal temperature reached to 160 F. Water (¾ cup) and Taco Seasoning (40 g) were added per 1 lb of ground beef and cooked until the sample reached to a boil stirring frequently. Once samples were cooked they were transferred to a warmer set at 140 F and covered with foil. Samples were served within 15-20 minutes after cooking. Each panelist was served about 2 oz of sample in 2 oz serving cups in a randomized sequential monadic order. Panelists were instructed to cleanse their palate with crackers and water in between tasting samples. EyeQuestion sensory software was used to collect the data. Data was analyzed using ANOVA at 5% significance level (or 95% confidence interval). Means were compared using Tukey's HDS test.

After reviewing the taco seasoning incorporated with the ground beef, there were no significant differences among the samples for all hedonic measurements (overall appearance, overall color, overall liking, overall flavor, saltiness, overall strength of seasoning, juiciness and overall texture) at 95% confidence level. Results are in Table 16.

TABLE 16
Mean Hedonic Liking Measurement by Product

| | Control with | Test 1 with | Test 2 with |
|---|---|---|---|
| | Maltodextrin | Rice | Cassava |
| Overall Appearance | 6.9^{a} | 6.7^{a} | 6.6^{a} |
| Overall Color | 6.8^{a} | 6.4^{a} | 6.6^{a} |
| Overall Liking | 6.3^{a} | 6.1^{a} | 6.2^{a} |
| Overall Flavor | 6.4^{a} | 6.4^{a} | 6.3^{a} |
| Saltiness | 6.4^{a} | 6.2^{a} | 6.2^{a} |
| Overall Strength of | 6.4^{a} | 6.4^{a} | 6.1^{a} |
| Seasoning | | | |
| Juiciness | 6.6^{a} | 6.5^{a} | 6.6^{a} |
| Overall Texture | 6.3^{a} | 6.1^{a} | 6.3^{a} |

Means with different lower-case letters (a, b) indicated significant difference at p < 0.05.
9 Point Hedonic Scale used: 1 dislike extremely, 2 dislike very much, 3 dislike moderately, 4 dislike slightly, 5 neither like nor dislike, 6 like slightly, 7 like moderately, 8 like very much, 9 like extremely.

1. An instant or prepared sauce comprising a soluble flour and at least one additional ingredient.

2. The instant or prepared sauce of claim 1, wherein the soluble flour has a dextrose equivalent value ranging from 5 to 18, a solubility greater than 50% at 5% solids, and a viscosity between 0.001 and 1.0 Pa*s at temperatures ranging from 20-50 C at 10% solids.

3. The instant or prepared sauce of claim 2, wherein the soluble flour has a dextrose equivalent ranging from 8 to 12.

4. The instant or prepared sauce of claim 2, wherein the soluble flour has a protein content ranging from 0 to 10 wt %.

5. The instant or prepared sauce of claim 2, wherein the soluble flour has a dietary fiber content ranging from 0.5 to 15 wt %.

6. The instant or prepared sauce of claim 2, wherein the soluble flour has a solubility ranging from 50% to 100%.

7. The instant or prepared sauce of claim 1, wherein the soluble flour is soluble cassava flour.

8. The instant or prepared sauce of claim 1, wherein the soluble flour is soluble rice flour.

9. The instant or prepared sauce of claim 1, wherein no maltodextrin is present.

10. A dry mix seasoning comprising a soluble flour and at least one additional ingredient.

11. The dry mix seasoning of claim 10, wherein the soluble flour has a dextrose equivalent value ranging from 5 to 18, a solubility greater than 50% at 5% solids, and a viscosity between 0.001 and 1.0 Pa*s at temperatures ranging from 20-50 C at 10% solids.

12. The dry mix seasoning of claim 11, wherein the soluble flour has a dextrose equivalent ranging from 8 to 12.

13. The dry mix seasoning of claim 11, wherein the soluble flour has a protein content ranging from 0 to 10 wt %.

14. The dry mix seasoning of claim 11, wherein the soluble flour has a dietary fiber content ranging from 0.5 to 15 wt %.

15. The dry mix seasoning of claim 11, wherein the soluble flour has a solubility ranging from 50% to 100%.

16. The dry mix seasoning of claim 10, wherein the soluble flour is soluble cassava flour.

17. The dry mix seasoning of claim 10, wherein the soluble flour is soluble rice flour.

18. The dry mix seasoning of claim 10, wherein no maltodextrin is present.
